(19) United States
(12) Patent Application Publication
(10) Pub. No.: US 2026/0251110 A1
(43) Pub. Date: Aug. 27, 2026

(54) ENGINE SYSTEM

(71) Applicant: SUBARU CORPORATION, Tokyo (JP)

(72) Inventor: Takeshi SAITO, Tokyo (JP)

(21) Appl. No.: 19/531,237

(22) Filed: Feb. 5, 2026

(30) Foreign Application Priority Data
Feb. 21, 2025 (JP) 2025-027369

(51) Int. Cl. F02M 26/35; F02M 26/38; F02M 26/42; F02M 26/45

(52) U.S. Cl. CPC F02M 26/35; F01N 3/0232; F01N 3/0233; F02M 26/10; F02M 26/15; F02M 26/38; F02M 26/42; F02M 26/45

(57) ABSTRACT

An engine system includes an engine, an intake passage, an exhaust passage, at least one EGR passage, a filter, a sensor, a throttle valve, an exhaust valve, at least one EGR valve, and a control device. The control device is configured to accumulate exhaust gas in the exhaust passage by closing the exhaust valve and the EGR valve, and then execute exhaust gas backflow control for causing the exhaust gas accumulated in the exhaust passage to flow backward to the intake passage by opening the EGR valve. The control device is configured to reduce a backflow rate of the exhaust gas by opening the exhaust valve or controlling opening and closing of the EGR valve based on a rate of a decrease in a differential pressure detected by the sensor during execution of the exhaust gas backflow control.

### CROSS-REFERENCE TO RELATED APPLICATIONS

The present application claims priority from Japanese Patent Application No. 2025-027369 filed on February 21, 2025, the entire contents of which are hereby incorporated by reference.

### BACKGROUND

The disclosure relates to an engine system.

Ash is particulate matter such as soot and an unburned residue of engine oil that are contained in exhaust gas discharged from an engine. A diesel particulate filter (DPF), a gasoline particulate filter (GPF), and the like are known as filters for vehicles that remove this ash. Such a filter is provided in an exhaust passage of the exhaust gas, and removes the particulate matter and the ash from the exhaust gas by trapping the particulate matter and the ash at the pores formed in the filter. The particulate matter trapped at the pores of the filter is removed by combustion. The ash trapped at the pores of the filter remains without being removed by combustion. Therefore, when the filter is continuously used, the pores formed in the filter are gradually clogged with the ash.

In a technology described in Japanese Patent No. 3424584, an ash desorption operation is executed to remove ash deposited on a filter by causing exhaust gas to flow backward. Specifically, in the technology described in Japanese Patent No. 3424584, the filter is provided between an exhaust port of each cylinder and an exhaust manifold. When the travel distance of the vehicle is equal to or greater than a predetermined amount, determination is made that the ash deposition amount in the filter has increased to an allowable upper limit amount, and the exhaust gas is caused to flow backward from the exhaust manifold toward the exhaust port. As a result, the ash deposited on the filter is blown off and removed.

### SUMMARY

An aspect of the disclosure provides an engine system including an engine, an intake passage, an exhaust passage, at least one EGR passage, a filter, a sensor, a throttle valve, an exhaust valve, at least one EGR valve, and a control device. The intake passage is coupled to the engine. The exhaust passage is coupled to the engine. The at least one EGR passage couples the exhaust passage and the intake passage. The filter is provided in the exhaust passage. The sensor is configured to detect a differential pressure of exhaust gas between an upstream side and a downstream side of the filter. The throttle valve is provided in the intake passage. The exhaust valve is provided downstream of the filter in the exhaust passage. The at least one EGR valve is provided in the at least one EGR passage. The control device is configured to control opening and closing of the throttle valve, the exhaust valve, and the at least one EGR valve. The control device is configured to accumulate the exhaust gas in the exhaust passage by closing the exhaust valve and the at least one EGR valve, and then execute exhaust gas backflow control for causing the exhaust gas accumulated in the exhaust passage to flow backward to the intake passage by opening the at least one EGR valve. The control device is configured to reduce a backflow rate of the exhaust gas by opening the exhaust valve or controlling the opening and closing of the at least one EGR valve based on a rate of a decrease in the differential pressure detected by the sensor during execution of the exhaust gas backflow control.

An aspect of the disclosure provides an engine system including an engine, an intake passage, an exhaust passage, at least one EGR passage, a filter, a sensor, a throttle valve, an exhaust valve, at least one EGR valve, and circuitry. The intake passage is coupled to the engine. The exhaust passage is coupled to the engine. The at least one EGR passage couples the exhaust passage and the intake passage. The filter is provided in the exhaust passage. The sensor is configured to detect a differential pressure of exhaust gas between an upstream side and a downstream side of the filter. The throttle valve is provided in the intake passage. The exhaust valve is provided downstream of the filter in the exhaust passage. The at least one EGR valve is provided in the at least one EGR passage. The circuitry is configured to control opening and closing of the throttle valve, the exhaust valve, and the at least one EGR valve. The circuitry is configured to accumulate the exhaust gas in the exhaust passage by closing the exhaust valve and the at least one EGR valve, and then execute exhaust gas backflow control for causing the exhaust gas accumulated in the exhaust passage to flow backward to the intake passage by opening the at least one EGR valve. The circuitry is configured to reduce a backflow rate of the exhaust gas by opening the exhaust valve or controlling the opening and closing of the at least one EGR valve based on a rate of a decrease in the differential pressure detected by the sensor during execution of the exhaust gas backflow control.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating a schematic configuration of an engine system according to an embodiment of the disclosure;

FIG. 2 is a block diagram illustrating an example of a hardware configuration of a control device according to the embodiment;

FIG. 3 is a block diagram illustrating an example of a functional configuration of the control device according to the embodiment;

FIG. 4 is a flowchart illustrating a flow of an exhaust gas backflow process according to the embodiment;

FIG. 5 illustrates a flow of exhaust gas according to the embodiment;

FIG. 6 illustrates a flow of the exhaust gas according to the embodiment;

FIG. 7 illustrates a flow of exhaust gas according to an embodiment; and

FIG. 8 illustrates a flow of the exhaust gas according to the embodiment.

### DETAILED DESCRIPTION

In the technology described in Japanese Patent No. 3424584, the ash removed from the filter by the ash desorption operation in which the exhaust gas is caused to flow backward from the exhaust manifold toward the exhaust port may enter the cylinder of the engine. When the ash enters the cylinder of the engine due to the ash desorption operation, components of the engine such as a cylinder and piston rings may malfunction, and the durability of the engine may decrease.

It is desirable to provide an engine system that can suppress an inflow of ash into an engine cylinder during exhaust gas backflow control for eliminating clogging of a filter.

Hereinafter, embodiments of the disclosure will be described in detail with reference to the accompanying drawings. Specific dimensions, materials, numerical values, and the like described in the embodiments are examples for facilitating understanding of the embodiments of the disclosure, and do not limit the embodiments of the disclosure unless otherwise specified. In this specification and the drawings, elements having substantially the same functions and configurations are denoted by the same reference numerals to omit redundant description, and elements not directly related to the embodiments of the disclosure are not illustrated.

### First Embodiment

### Configuration of Engine System 100

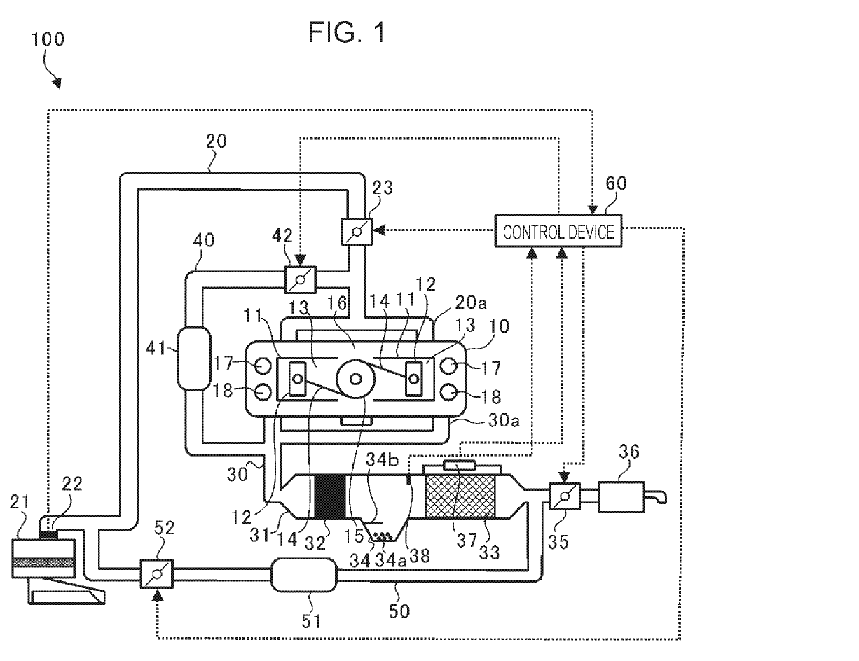

An engine system 100 according to a first embodiment of the disclosure will be described with reference to FIG. 1. FIG. 1 is a schematic diagram illustrating a schematic configuration of the engine system 100 according to the first embodiment.

As illustrated in FIG. 1, the engine system 100 includes an engine 10, an intake passage 20, an exhaust passage 30, an HP-EGR passage 40, an LP-EGR passage 50, and a control device 60.

The engine 10 is, for example, a horizontally opposed engine in which a plurality of cylinders 11 is disposed to face each other. However, the engine 10 may be an engine other than the horizontally opposed engine. Inside the cylinder 11, a piston 12 is slidably provided. A combustion chamber 13 is defined by the inner circumferential surface of the cylinder 11 and the crown surface of the piston 12. One end of a connecting rod 14 is coupled to the piston 12. The other end of the connecting rod 14 is coupled to a crankshaft 15. The crankshaft 15 is rotatably supported by a bearing (not illustrated) in a crank chamber 16.

An intake port 17 and an exhaust port 18 are formed in each cylinder 11. The intake port 17 and the exhaust port 18 communicate with the combustion chamber 13. The combustion chamber 13 communicates with the intake passage 20 via the intake port 17, and communicates with the exhaust passage 30 via the exhaust port 18. The intake port 17 is opened and closed by an intake valve (not illustrated). The exhaust port 18 is opened and closed by an exhaust valve (not illustrated). By driving the intake valve and the exhaust valve, intake air is supplied to the combustion chamber 13 and exhaust gas is discharged from the combustion chamber 13.

The intake passage 20 is coupled to the engine 10. The intake passage 20 is a passage through which intake air that is air to be supplied to the combustion chamber 13 of the engine 10 flows. An air cleaner 21 is provided at an intake port on the upstream side of the intake passage 20. The air cleaner 21 removes foreign matter contained in the air taken into the intake passage 20. Therefore, the air cleaner 21 is provided with a filter for removing the foreign matter contained in the air.

An air flow meter 22 is provided downstream of the air cleaner 21 in the intake passage 20. For example, the air flow meter 22 is provided at a discharge port of the air cleaner 21. The air flow meter 22 measures the amount of air taken into the intake passage 20.

A throttle valve 23 is provided downstream of the air flow meter 22 in the intake passage 20. The throttle valve 23 controls the supply of intake air from the intake passage 20 to the engine 10. The supply of intake air to the engine 10 is controlled in accordance with the opening degree of the throttle valve 23. For example, when the throttle valve 23 is closed (the opening degree is 0%), the intake passage 20 and the engine 10 are shut off from each other, and the intake air is not supplied to the engine 10 through the intake passage 20. When the throttle valve 23 is open (the opening degree is larger than 0%), the intake passage 20 and the engine 10 communicate with each other, and the intake air is supplied to the engine 10 through the intake passage 20. In this way, the throttle valve 23 controls the supply of the intake air from the intake passage 20 to the engine 10 by shutting off or allowing communication between the intake passage 20 and the engine 10 in response to the opening and closing of the throttle valve 23.

As described above, the combustion chamber 13 of the engine 10 communicates with the intake passage 20 via the intake port 17, and communicates with the exhaust passage 30 via the exhaust port 18. When the intake passage 20 communicates with the combustion chamber 13 of the engine 10 by the intake valve of the intake port 17 and the combustion chamber 13 communicates with the exhaust passage 30 by the exhaust valve of the exhaust port 18, the intake passage 20 communicates with the exhaust passage 30 via the combustion chamber 13. When the intake passage 20 and the combustion chamber 13 of the engine 10 are shut off from each other by the intake valve of the intake port 17 or when the combustion chamber 13 and the exhaust passage 30 are shut off from each other by the exhaust valve of the exhaust port 18, the communication between the intake passage 20 and the exhaust passage 30 is shut off. In this way, the throttle valve 23 is provided to shut off or allow the communication between the intake passage 20 and the exhaust passage 30.

An intake manifold 20a is provided downstream of the throttle valve 23 in the intake passage 20. The intake manifold 20a branches toward the cylinders 11 of the engine 10 and is coupled to the intake ports 17 of the cylinders 11. The air taken into the intake passage 20 through the air cleaner 21 passes through the throttle valve 23 and is sent to the combustion chamber 13 of the engine 10 through the intake manifold 20a.

The exhaust passage 30 is coupled to the engine 10. The exhaust passage 30 is a passage through which exhaust gas discharged from the combustion chamber 13 of the engine 10 flows. An exhaust manifold 30a is provided on the upstream side of the exhaust passage 30. The exhaust manifold 30a branches toward the cylinders 11 of the engine 10 and is coupled to the exhaust ports 18 of the cylinders 11.

A purification device 31 is provided downstream of the exhaust manifold 30a in the exhaust passage 30. The purification device 31 includes a catalyst 32, a filter 33, and an ash storage portion 34. The catalyst 32 removes harmful substances contained in the exhaust gas discharged from the combustion chamber 13. For example, the catalyst 32 is a three-way catalyst containing catalytic components such as platinum (Pt), palladium (Pd), and rhodium (Rh), and removes hydrocarbons (HC), carbon monoxide (CO), and nitrogen oxides (NO_{X}) from the exhaust gas.

The filter 33 is provided downstream of the catalyst 32 in the purification device 31. The filter 33 is a particulate filter that traps particulate matter such as soot in the exhaust gas and ash that is an unburned residue of engine oil. For example, the filter 33 is a gasoline particulate filter (GPF) or a diesel particulate filter (DPF).

The ash storage portion 34 stores ash 34a separated from the filter 33 by executing an exhaust gas backflow process described later. The ash storage portion 34 is provided between the catalyst 32 and the filter 33. However, the position where the ash storage portion 34 is provided is not limited to the position between the catalyst 32 and the filter 33, and the ash storage portion 34 may be provided upstream of the filter 33. For example, the ash storage portion 34 may be provided upstream of the catalyst 32 in the purification device 31. The ash storage portion 34 is provided in the purification device 31 to protrude downward. Therefore, in the purification device 31, the bottom of the portion where the ash storage portion 34 is provided is deeper than the bottom of the portion where the ash storage portion 34 is not provided. The ash storage portion 34 is a recessed portion formed in the bottom of the purification device 31.

The ash storage portion 34 is provided with a lid 34b. The lid 34b covers an upstream part of the top opening of the ash storage portion 34. For example, the lid 34b is provided to protrude downstream from the upstream side surface of the ash storage portion 34. The lid 34b prevents the ash 34a stored in the ash storage portion 34 from being stirred up again by the exhaust gas.

An exhaust valve 35 is provided downstream of the purification device 31 in the exhaust passage 30. The exhaust valve 35 is a valve that adjusts the flow rate of the exhaust gas discharged to the outside of the vehicle through the exhaust passage 30. The flow rate of the exhaust gas discharged to the outside of the vehicle changes depending on the opening degree of the exhaust valve 35. The exhaust valve 35 may be, for example, an exhaust control valve (ECV) generally provided in the exhaust passage 30, or may be a valve newly provided in the exhaust passage 30 separately from the existing ECV.

A muffler 36 is provided downstream of the exhaust valve 35 in the exhaust passage 30. The muffler 36 reduces noise when the exhaust gas is discharged to the outside of the vehicle. The exhaust gas discharged from the combustion chamber 13 of the engine 10 passes through the catalyst 32 and the filter 33 of the purification device 31 and the muffler 36 in the exhaust passage 30 in this order, and is discharged to the outside of the vehicle.

The exhaust passage 30 is provided with a pressure sensor 37 and a temperature sensor 38. The pressure sensor 37 is a sensor that detects the pressure of the exhaust gas in the exhaust passage 30. For example, the pressure sensor 37 may be a differential pressure sensor generally provided in the exhaust passage 30, or may be a pressure sensor newly provided in the exhaust passage 30 separately from the existing differential pressure sensor. The generally provided differential pressure sensor detects a difference (differential pressure) between a pressure on the upstream side of the filter 33 and a pressure on the downstream side of the filter 33, and is used for determination on clogging or the like of the filter 33. In the present embodiment, the generally provided differential pressure sensor is used as the pressure sensor 37. Therefore, the pressure sensor 37 is provided such that two measurement units are positioned on the upstream side and the downstream side of the filter 33. Thus, the existing differential pressure sensor can be effectively used as the pressure sensor 37 for detecting the pressure of the exhaust gas. In a case where the pressure sensor newly provided separately from the generally provided differential pressure sensor is used as the pressure sensor 37, the pressure sensor may be provided in the exhaust passage 30, and the installation location thereof is not particularly limited.

The temperature sensor 38 is a sensor that detects the temperature of the exhaust gas in the exhaust passage 30. For example, the temperature sensor 38 may be a temperature sensor generally provided in the exhaust passage 30, or may be a temperature sensor newly provided in the exhaust passage 30 separately from the existing temperature sensor. In the present embodiment, among the temperature sensors generally provided in the exhaust passage 30, a temperature sensor provided to monitor overheating of the catalyst 32 is used as the temperature sensor 38 that detects the temperature of the exhaust gas. Therefore, the temperature sensor 38 is provided between the catalyst 32 and the filter 33. In a case where the temperature sensor newly provided separately from the generally provided temperature sensor is used as the temperature sensor 38, the temperature sensor may be provided in the exhaust passage 30, and the installation location thereof is not particularly limited.

The high pressure loop exhaust gas recirculation (HP-EGR) passage 40 is a recirculation passage that couples the intake passage 20 and the exhaust passage 30. The HP-EGR passage 40 is a passage for recirculation of the exhaust gas (EGR gas) directly bypassing the intake passage 20 and the exhaust passage 30 without passing through the combustion chamber 13 of the engine 10. In one embodiment, the HP-EGR passage 40 may serve as a first EGR passage or an EGR passage. In the engine system 100, the exhaust gas discharged from the combustion chamber 13 of the engine 10 to the exhaust passage 30 is recirculated from the exhaust passage 30 to the intake passage 20 via the HP-EGR passage 40. For example, one end of the HP-EGR passage 40 is coupled to the downstream side of the throttle valve 23 in the intake passage 20. The other end of the HP-EGR passage 40 is coupled between the exhaust manifold 30a and the purification device 31 in the exhaust passage 30. Hereinafter, in the HP-EGR passage 40, the exhaust passage 30 side is referred to as an upstream side, and the intake passage 20 side is referred to as a downstream side.

The HP-EGR passage 40 is provided with an HP-EGR cooler 41. The HP-EGR cooler 41 cools the exhaust gas recirculated from the exhaust passage 30 to the intake passage 20. An HP-EGR valve 42 is provided downstream of the HP-EGR cooler 41 in the HP-EGR passage 40. The HP-EGR valve 42 controls the recirculation of the exhaust gas from the exhaust passage 30 to the intake passage 20 through the HP-EGR passage 40. The recirculation of the exhaust gas from the exhaust passage 30 to the intake passage 20 through the HP-EGR passage 40 is controlled in accordance with the opening degree of the HP-EGR valve 42. For example, when the HP-EGR valve 42 is closed, that is, when the opening degree of the HP-EGR valve 42 is 0%, the HP-EGR passage 40 is shut off, and the exhaust gas in the exhaust passage 30 is not recirculated to the intake passage 20 through the HP-EGR passage 40. When the HP-EGR valve 42 is open, that is, when the opening degree of the HP-EGR valve 42 is larger than 0% and 100% or smaller, the intake passage 20 and the exhaust passage 30 communicate with each other through the HP-EGR passage 40, and the exhaust gas in the exhaust passage 30 is recirculated to the intake passage 20 through the HP-EGR passage 40. In one embodiment, the HP-EGR valve 42 may serve as a first EGR valve or an EGR valve.

The low pressure loop exhaust gas recirculation (LP-EGR) passage 50 is a recirculation passage that couples the intake passage 20 and the exhaust passage 30. The LP-EGR passage 50 is a passage for recirculation of the exhaust gas (EGR gas) directly bypassing the intake passage 20 and the exhaust passage 30 without passing through the combustion chamber 13 of the engine 10. In one embodiment, the LP-EGR passage 50 may serve as a second EGR passage. In the engine system 100, the exhaust gas is recirculated from the exhaust passage 30 to the intake passage 20 via the LP-EGR passage 50. That is, in the engine system 100, the exhaust gas discharged from the combustion chamber 13 of the engine 10 to the exhaust passage 30 is recirculated from the exhaust passage 30 to the intake passage 20 via the HP-EGR passage 40 and the LP-EGR passage 50. For example, one end of the LP-EGR passage 50 is coupled between each of the air cleaner 21 and the air flow meter 22 and the throttle valve 23 in the intake passage 20. The other end of the LP-EGR passage 50 is coupled between the purification device 31 and the exhaust valve 35 in the exhaust passage 30. Hereinafter, in the LP-EGR passage 50, the exhaust passage 30 side is referred to as an upstream side, and the intake passage 20 side is referred to as a downstream side.

The LP-EGR passage 50 is provided with an LP-EGR cooler 51. The LP-EGR cooler 51 cools the exhaust gas recirculated from the exhaust passage 30 to the intake passage 20. An LP-EGR valve 52 is provided downstream of the LP-EGR cooler 51 in the LP-EGR passage 50. The LP-EGR valve 52 controls the recirculation of the exhaust gas from the exhaust passage 30 to the intake passage 20 through the LP-EGR passage 50. The recirculation of the exhaust gas from the exhaust passage 30 to the intake passage 20 through the LP-EGR passage 50 is controlled in accordance with the opening degree of the LP-EGR valve 52. For example, when the LP-EGR valve 52 is closed, that is, when the opening degree of the LP-EGR valve 52 is 0%, the LP-EGR passage 50 is shut off, and the exhaust gas in the exhaust passage 30 is not recirculated to the intake passage 20 through the LP-EGR passage 50. When the LP-EGR valve 52 is open, that is, when the opening degree of the LP-EGR valve 52 is larger than 0% and 100% or smaller, the exhaust passage 30 and the intake passage 20 communicate with each other through the LP-EGR passage 50, and the exhaust gas in the exhaust passage 30 is recirculated to the intake passage 20 through the LP-EGR passage 50. In one embodiment, the LP-EGR valve 52 may serve as a second EGR valve.

The control device 60 communicates with each device provided in the engine system 100. For example, the control device 60 communicates with the air flow meter 22, the pressure sensor 37, the temperature sensor 38, the throttle valve 23, the exhaust valve 35, the HP-EGR valve 42, and the LP-EGR valve 52. The control device 60 acquires various types of information from the air flow meter 22, the pressure sensor 37, and the temperature sensor 38, and controls the opening degrees of the throttle valve 23, the exhaust valve 35, the HP-EGR valve 42, and the LP-EGR valve 52 based on the acquired information.

### Hardware Configuration of Control Device 60

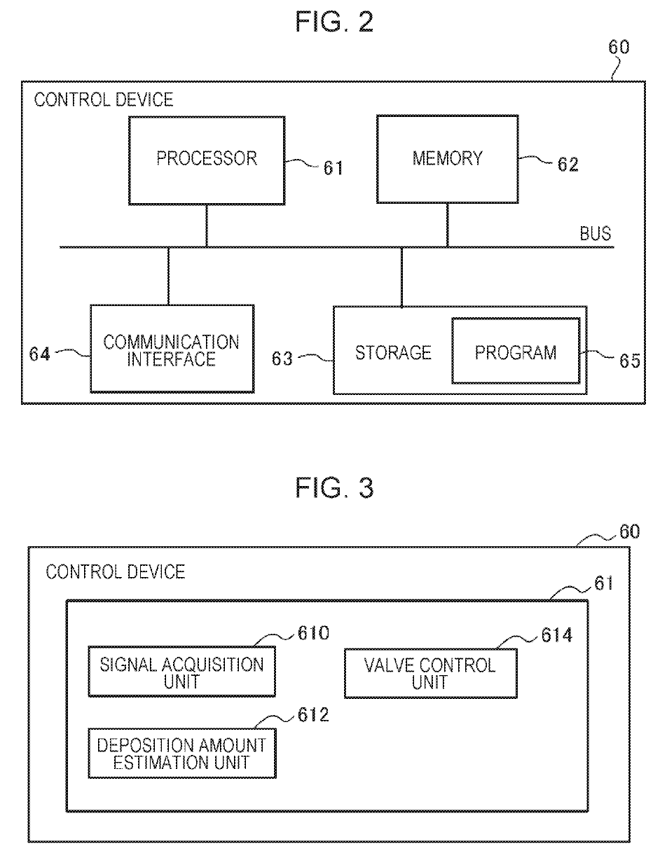

A hardware configuration of the control device 60 included in the engine system 100 according to the present embodiment will be described with reference to FIG. 2. FIG. 2 is a block diagram illustrating an example of the hardware configuration of the control device 60.

As illustrated in FIG. 2, the control device 60 includes a processor 61, a memory 62, a storage 63, and a communication interface 64. The processor 61, the memory 62, the storage 63, and the communication interface 64 are coupled to each other via a bus.

The storage 63 stores a program 65. The processor 61 loads the program 65 stored in the storage 63 on the memory 62. The processor 61 executes each process included in the exhaust gas backflow process described later in accordance with a command included in the program 65 loaded on the memory 62. Examples of a device that can be used as the processor 61 include an electronic control unit (ECU). Examples of a device that can be used as the memory 62 include a semiconductor random access memory (RAM). Examples of a device that can be used as the storage 63 include a hard disk drive (HDD) and a solid state drive (SSD).

The communication interface 64 is an interface for communication with each device provided in the engine system 100 via a network. Examples of the interface that can be used as the communication interface 64 include networks such as a controller area network (CAN) and a local interconnect network (LIN), and an internetwork including these networks.

The program 65 for causing the processor 61 to execute the exhaust gas backflow process may be recorded in a computer-readable non-volatile recording medium. This recording medium may be the storage 63, or may be another recording medium. Examples of the other recording medium include a semiconductor memory, a programmable logic circuit, and a disc recording medium.

In the present embodiment, the exhaust gas backflow process is executed using a single processor (processor 61), but the embodiment of the disclosure is not limited thereto. For example, the exhaust gas backflow process may be executed using a plurality of processors. In this case, the plurality of processors that executes the exhaust gas backflow process may be provided in a single device (control device 60), or may be distributed in a plurality of devices. In a case where the plurality of processors is distributed in the plurality of devices, the plurality of devices may be configured to communicate with each other via a network such as a CAN or a LIN.

### Functional Configuration of Control Device 60

A functional configuration of the control device 60 included in the engine system 100 according to the present embodiment will be described with reference to FIG. 3. FIG. 3 is a block diagram illustrating an example of the functional configuration of the control device 60. The processor 61 of the control device 60 functions as a signal acquisition unit 610, a deposition amount estimation unit 612, and a valve control unit 614 by executing the program 65 stored in the storage 63.

The signal acquisition unit 610 acquires a detection value from the pressure sensor 37. For example, the signal acquisition unit 610 acquires, as the detection value from the pressure sensor 37, a difference (differential pressure) between a pressure value detected by the measurement unit positioned on the upstream side of the filter 33 and a pressure value detected by the measurement unit positioned on the downstream side of the filter 33. Hereinafter, the difference between the pressure on the upstream side of the filter 33 and the pressure on the downstream side of the filter 33 is referred to as "differential pressure of the filter 33." The signal acquisition unit 610 acquires a pressure value detected by the measurement unit positioned on the downstream side of the filter 33 as the detection value from the pressure sensor 37.

The deposition amount estimation unit 612 estimates an ash deposition amount in the filter 33 based on the detection value from the pressure sensor 37 acquired by the signal acquisition unit 610. For example, when the value of the differential pressure of the filter 33 acquired by the signal acquisition unit 610 after a regeneration process is equal to or greater than a threshold, the deposition amount estimation unit 612 determines that the ash deposition amount in the filter 33 is equal to or greater than a predetermined amount. The threshold is determined in advance based on the relationship between the value of the differential pressure of the filter 33 detected by the pressure sensor 37 and the ash deposition amount. The relationship between the value of the differential pressure of the filter 33 detected by the pressure sensor 37 and the ash deposition amount is obtained in advance by a test, a simulation, or the like. Information indicating the threshold is held in the storage 63. The regeneration process is a process of supplying air to the filter 33 to burn and remove particulate matter trapped at the pores of the filter 33.

As described above, the exhaust gas discharged from the engine 10 contains particulate matter such as soot and ash that is an unburned residue of engine oil. Since the particulate matter and the ash are trapped from the exhaust gas at the pores of the filter 33, the particulate matter and the ash are deposited on the filter 33. When the filter 33 is continuously used, the filter 33 is clogged with the particulate matter and the ash. In the engine system 100, when the deposition amount of the particulate matter and the ash in the filter 33 is equal to or greater than the predetermined amount, the regeneration process is executed to eliminate the clogging of the filter 33.

For example, the engine system 100 executes the regeneration process when the value of the differential pressure of the filter 33 detected by the pressure sensor 37 is equal to or greater than a predetermined threshold. The threshold is determined in advance based on the relationship between the value of the differential pressure of the filter 33 and the deposition amount of the particulate matter and the ash. For example, the value of the differential pressure corresponding to the maximum amount of particulate matter that can be burned by the regeneration process is determined as the threshold. Information indicating the threshold is held in the storage 63.

In the regeneration process, the particulate matter trapped at the pores of the filter 33 can be burned and removed, but the ash cannot be physically removed. Thus, the ash remains in the filter 33 after the execution of the regeneration process. Therefore, the engine system 100 estimates the ash deposition amount in the filter 33 based on the differential pressure of the filter 33 after the execution of the regeneration process.

The valve control unit 614 controls the opening degrees (0% to 100%) of the throttle valve 23, the exhaust valve 35, the HP-EGR valve 42, and the LP-EGR valve 52. For example, when the ash deposition amount in the filter 33 is equal to or greater than the predetermined amount, the valve control unit 614 controls the opening degrees of the throttle valve 23, the exhaust valve 35, the HP-EGR valve 42, and the LP-EGR valve 52 to cause the exhaust gas to flow backward.

### Operation of Engine System 100

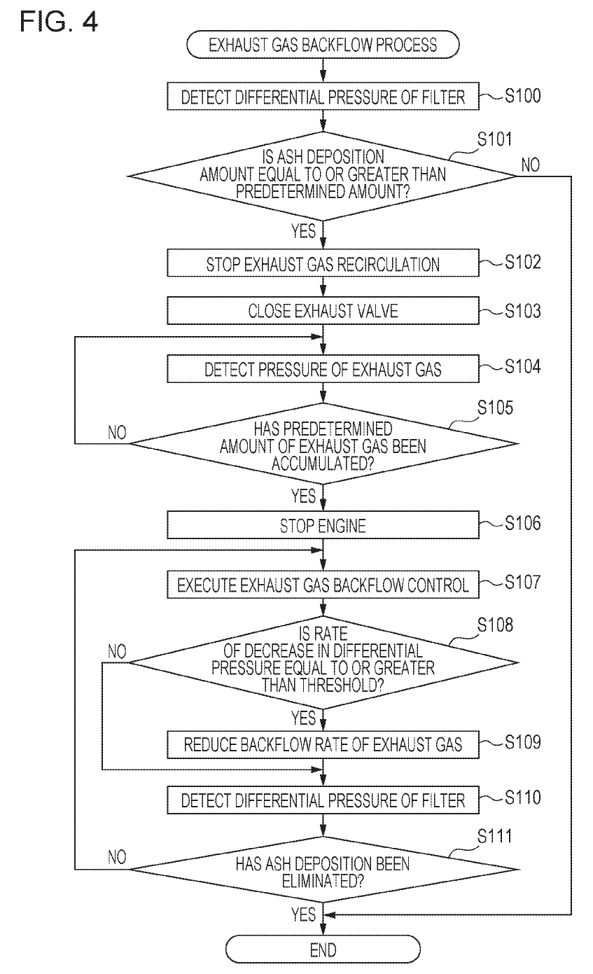

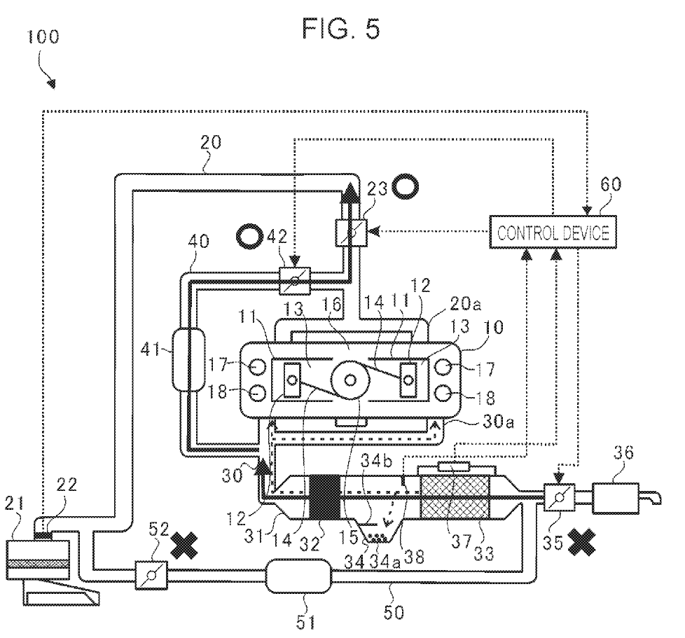

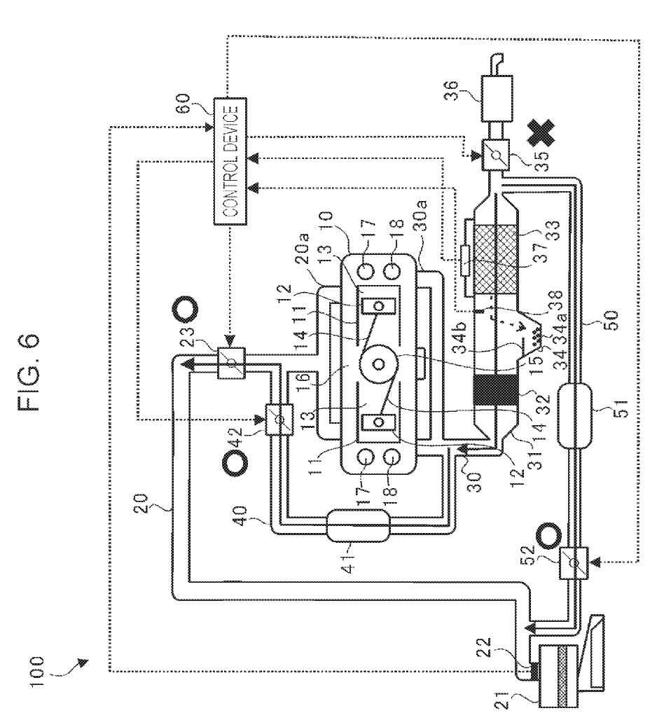

The operation of the engine system 100 will be described with reference to FIGS. 4 to 6. FIG. 4 is a flowchart illustrating the exhaust gas backflow process to be executed by the engine system 100. FIGS. 5 and 6 illustrate a flow of the exhaust gas. In particular, FIG. 5 illustrates the opening/closing states of the valves and the flow of the exhaust gas when the exhaust gas backflow control (S107) is executed. FIG. 6 illustrates the opening/closing states of the valves and the flow of the exhaust gas when the backflow rate is reduced (S109) during the exhaust gas backflow control (S107).

As illustrated in FIG. 4, the exhaust gas backflow process includes steps S100 to S111. The engine system 100 may execute the exhaust gas backflow process every time the regeneration process for the filter 33 described above is executed. Alternatively, the engine system 100 may execute the exhaust gas backflow process at an appropriate timing regardless of whether the regeneration process is executed.

In step S100, the pressure sensor 37 detects a differential pressure of the filter 33. Then, the control device 60 acquires the value of the differential pressure of the filter 33 from the pressure sensor 37. During the operation of the engine system 100, the pressure sensor 37 constantly measures the differential pressure of the filter 33.

In step S101, the control device 60 determines whether the ash deposition amount in the filter 33 is equal to or greater than the predetermined amount. The control device 60 determines whether the ash deposition amount in the filter 33 is equal to or greater than the predetermined amount based on the value of the differential pressure of the filter 33 detected in step S100. For example, when the value of the differential pressure of the filter 33 is equal to or greater than the predetermined threshold, the control device 60 determines that the ash deposition amount in the filter 33 is equal to or greater than the predetermined amount. When the differential pressure of the filter 33 is smaller than the threshold, the control device 60 determines that the ash deposition amount in the filter 33 is smaller than the predetermined amount.

When determination is made that the ash deposition amount in the filter 33 is equal to or greater than the predetermined amount (YES in step S101), the process proceeds to step S102. When determination is made that the ash deposition amount in the filter 33 is smaller than the predetermined amount (NO in step S101), the exhaust gas backflow process is terminated.

In step S102, the control device 60 stops recirculation of exhaust gas (EGR gas) from the exhaust passage 30 to the intake passage 20. For example, the control device 60 closes the HP-EGR valve 42 and the LP-EGR valve 52. The control device 60 keeps the throttle valve 23 open. When the throttle valve 23 is open, supply of intake air from the intake passage 20 to the engine 10 is continued, and exhaust gas continues to flow from the engine 10 into the exhaust passage 30.

In step S103, the control device 60 closes the exhaust valve 35. As a result, the exhaust gas is not discharged to the outside of the vehicle through the muffler 36, and the exhaust gas is accumulated in the exhaust passage 30. Since the HP-EGR valve 42 and the LP-EGR valve 52 are closed in step S102, the exhaust gas accumulated in the exhaust passage 30 is not recirculated to the intake passage 20 through the HP-EGR passage 40 and the LP-EGR passage 50. Therefore, the pressure of the exhaust gas present in the portion upstream of the HP-EGR valve 42 in the HP-EGR passage 40, the portion upstream of the LP-EGR valve 52 in the LP-EGR passage 50, and the exhaust passage 30 increases.

In step S104, the pressure sensor 37 detects the pressure of the exhaust gas in the exhaust passage 30. For example, the control device 60 acquires, as the pressure value of the exhaust gas, a pressure value detected by one of the two measurement units of the pressure sensor 37 that is positioned on the downstream side of the filter 33. In a case where a sensor that detects the pressure value of the exhaust gas is provided separately from the pressure sensor 37, the pressure value of the exhaust gas detected by the sensor may be used.

In step S105, the control device 60 determines whether a predetermined amount of exhaust gas has been accumulated in the exhaust passage 30. The control device 60 determines whether the predetermined amount of exhaust gas has been accumulated in the exhaust passage 30 based on the pressure value of the exhaust gas in the exhaust passage 30 detected in step S104. For example, when the pressure value of the exhaust gas in the exhaust passage 30 detected in step S104 is equal to or greater than a threshold, the control device 60 determines that the predetermined amount of exhaust gas has been accumulated in the exhaust passage 30. The predetermined amount of exhaust gas is an amount of exhaust gas required to remove ash deposited on the filter 33. The threshold is determined in advance based on the relationship between the pressure value of the exhaust gas detected by the pressure sensor 37 and the amount of the exhaust gas accumulated in the exhaust passage 30. The relationship between the pressure value of the exhaust gas detected by the pressure sensor 37 and the amount of the exhaust gas accumulated in the exhaust passage 30 is obtained in advance by a test, a simulation, or the like. Information indicating the threshold is recorded in advance in the storage 63 or the like of the control device 60. For example, the pressure value (threshold) of the exhaust gas corresponding to the predetermined amount of exhaust gas (amount of exhaust gas required to remove ash deposited on the filter 33) is about twice to ten times as high as the pressure of the exhaust gas before the exhaust valve 35 is closed in step S103.

When determination is made that the predetermined amount of exhaust gas has been accumulated in the exhaust passage 30 (YES in step S105), the process proceeds to step S106. When determination is made that the predetermined amount of exhaust gas has not been accumulated (NO in step S106), the process returns to step S104.

In step S106, the control device 60 stops the operation of the engine 10. When the operation of the engine 10 is stopped, the exhaust gas is not discharged from the combustion chamber 13 of the engine 10. When the operation of the engine 10 is stopped before the predetermined amount of exhaust gas is accumulated in the exhaust passage 30, there is a possibility that the predetermined amount of exhaust gas is not accumulated in the exhaust passage 30. It is therefore preferable to stop the operation of the engine 10 after determination is made in step S105 that the predetermined amount of exhaust gas has been accumulated in the exhaust passage 30. As a result, a sufficient amount of exhaust gas can be caused to flow backward in the next exhaust gas backflow control (S107), and the ash deposited on the filter 33 can be reliably removed. The timing to stop the operation of the engine 10 is not particularly limited as long as the predetermined amount of exhaust gas is accumulated in the exhaust passage 30.

In step S107, the control device 60 executes the exhaust gas backflow control for causing the exhaust gas accumulated in the exhaust passage 30 to flow backward to the intake passage 20 through the HP-EGR passage 40 at a predetermined gas flow rate or higher. Hereinafter, the opening/closing states of the valves and the backflow of the exhaust gas when the exhaust gas backflow control is executed will be described with reference to FIG. 5. In FIGS. 5 to 8, the opening/closing state of each valve is indicated by "○" or "×." A case where the valve is open (the opening degree is larger than 0% and 100% or smaller) is indicated by "○," and a case where the valve is closed (the opening degree is 0%) is indicated by "×." In FIGS. 5 to 8, the backflow of the exhaust gas is indicated by solid arrows. The thickness of the solid arrow indicates the flow rate of the exhaust gas. As the solid arrow is thinner, the flow rate of the exhaust gas decreases. As the solid arrow is thicker, the flow rate of the exhaust gas increases. The dashed arrow indicates the flow of the exhaust gas containing the ash 34a removed from the filter 33.

In the exhaust gas backflow control (S107), the control device 60 opens the HP-EGR valve 42 to start the backflow of the exhaust gas. When the HP-EGR valve 42 is opened in the exhaust gas backflow control, as illustrated in FIG. 5, the throttle valve 23 and the HP-EGR valve 42 are open, and the exhaust valve 35 and the LP-EGR valve 52 remain closed. As a result, the predetermined amount or more of exhaust gas accumulated in the exhaust passage 30 flows backward to the intake passage 20 through the HP-EGR passage 40. When the exhaust gas flowing backward passes through the filter 33, the ash deposited on the filter 33 is physically removed and stored in the ash storage portion 34 adjacent to the filter 33.

When the flow rate of the exhaust gas flowing backward through the exhaust passage 30 in the exhaust gas backflow control is excessively high, there is a possibility that, as illustrated in FIG. 5, the ash 34a removed from the filter 33 is accelerated by the exhaust gas excessively flowing backward and is not stored in the ash storage portion 34. The ash 34a accelerated without being stored in the ash storage portion 34 may be carried by the exhaust gas excessively flowing backward, and may enter not only the HP-EGR passage 40 but also the combustion chamber 13 (that is, the cylinder) of the engine 10. When the ash 34a enters the combustion chamber 13 of the engine 10, components of the engine 10 such as the cylinders 11 and piston rings may malfunction, and the durability of the engine 10 such as a durable distance may decrease.

Returning to FIG. 4, the exhaust gas backflow process will be described. To address the above issue, in step S108, the control device 60 determines whether the backflow rate of the exhaust gas in the exhaust gas backflow control is appropriate. Specifically, the control device 60 determines whether the flow rate of the exhaust gas flowing backward from the exhaust passage 30 to the intake passage 20 (hereinafter sometimes referred to as "backflow rate of exhaust gas") is equal to or greater than a predetermined rate. For example, the control device 60 monitors a decrease in the differential pressure of the filter 33, and determines that the backflow rate of the exhaust gas is equal to or greater than the predetermined rate when the rate of the decrease in the differential pressure is equal to or greater than a threshold.

The threshold is determined in advance based on the relationship between the rate of the decrease in the differential pressure of the filter 33 and the backflow rate of the exhaust gas. Specifically, the relationship between the rate of the decrease in the differential pressure of the filter 33 and the backflow rate of the exhaust gas is obtained in advance by a test, a simulation, or the like. To prevent the ash 34a from entering the engine 10 in the exhaust gas backflow control (S107), an upper limit value and a lower limit value of an appropriate range of the backflow rate of the exhaust gas in the exhaust gas backflow control are obtained by a test, a simulation, or the like. The rate of the decrease in the differential pressure corresponding to the upper limit value of the appropriate range of the backflow rate of the exhaust gas is obtained from the above relationship. This rate of the decrease in the differential pressure can be determined as the threshold of the rate of the decrease in the differential pressure in the determination in S108. Information indicating the threshold of the rate of the decrease in the differential pressure is held in advance in the storage 63 of the control device 60. The processor 61 of the control device 60 reads the threshold held in advance in the storage 63 and executes the determination process in S108.

When determination is made that the rate of the decrease in the differential pressure is equal to or greater than the threshold (YES in step S108), the process proceeds to step S109. When determination is made that the rate of the decrease in the differential pressure is smaller than the threshold (NO in step S108), the process proceeds to step S110.

In step S109, the control device 60 reduces the backflow rate of the exhaust gas. For example, the control device 60 can reduce the backflow rate of the exhaust gas by opening the LP-EGR valve 52. Hereinafter, the opening/closing states of the valves and the backflow of the exhaust gas in this state will be described with reference to FIG. 6.

When the control device 60 opens the LP-EGR valve 52 in step S109, as illustrated in FIG. 6, the throttle valve 23, the HP-EGR valve 42, and the LP-EGR valve 52 are open, and only the exhaust valve 35 remains closed. Therefore, part of the exhaust gas accumulated in the exhaust passage 30 is recirculated to the intake passage 20 through the LP-EGR passage 50. As a result, the backflow rate of the exhaust gas from the exhaust passage 30 to the HP-EGR passage 40 becomes smaller than that before the LP-EGR valve 52 is opened (see FIG. 5). When the backflow rate of the exhaust gas from the exhaust passage 30 to the HP-EGR passage 40 decreases, the flow rate of the exhaust gas flowing backward in the exhaust passage 30 decreases. Therefore, most of the ash 34a removed from the filter 33 is separated from the low-speed backflow of the exhaust gas, and is stored in the ash storage portion 34. As a result, it is possible to suppress the entry of the ash 34a into the engine 10 along with the backflow of the exhaust gas.

Returning to FIG. 4, the exhaust gas backflow process will be described. In step S110, the control device 60 detects the differential pressure of the filter 33 as in step S100.

In step S111, the control device 60 determines whether the ash deposition in the filter 33 has been eliminated. For example, when the value of the differential pressure of the filter 33 detected by the pressure sensor 37 is equal to or smaller than a threshold, the control device 60 determines that the ash deposition in the filter 33 has been eliminated. The threshold is determined in advance based on the relationship between the value of the differential pressure of the filter 33 and the ash deposition amount in the filter 33. For example, the value of the differential pressure of the filter 33 in a case where ash is not deposited on the filter 33 is set as a reference value, and the value in the vicinity of the reference value is determined as the threshold. Information indicating the threshold is held in the storage 63. The processor 61 of the control device 60 reads the threshold held in advance in the storage 63 and executes the determination process in S111.

When determination is made that the ash deposition in the filter 33 has been eliminated (YES in step S111), the exhaust gas backflow process ends. When determination is made that the ash deposition in the filter 33 has not been eliminated (NO in step S108), the process returns to step S107, and the exhaust gas backflow control is executed again.

### Effects

Next, effects of the engine system 100 according to the first embodiment will be described.

In the engine system 100 according to the first embodiment, the control device 60 accumulates the exhaust gas in the exhaust passage 30 by closing the exhaust valve 35, the first EGR valve (for example, the HP-EGR valve 42), and the second EGR valve (for example, the LP-EGR valve 52). Subsequently, the control device 60 executes the exhaust gas backflow control for causing the exhaust gas accumulated in the exhaust passage 30 to flow backward to the intake passage 20 through the first EGR passage (for example, the HP-EGR passage 40) by opening the first EGR valve. Then, the control device 60 reduces the backflow rate of the exhaust gas by opening the second EGR valve based on the rate of the decrease in the differential pressure between the upstream and downstream sides of the filter 33 detected by the sensor (for example, the pressure sensor 37) during the execution of the exhaust gas backflow control. Accordingly, it is possible to suppress the inflow of the ash 34a into the combustion chamber 13 (cylinder) of the engine 10 that may occur when the backflow rate of the exhaust gas is equal to or greater than the predetermined rate during the execution of the exhaust gas backflow control for eliminating clogging of the filter 33. Therefore, it is possible to suppress damage to the engine 10 due to the ash 34a.

The engine system 100 further includes the ash storage portion 34 provided upstream of the filter 33 in the exhaust passage 30. The ash storage portion 34 stores the ash 34a separated from the filter 33 by the backflow of the exhaust gas during the execution of the exhaust gas backflow control. Thus, the ash 34a separated from the filter 33 is stored in the ash storage portion 34 and remains in the ash storage portion 34. The ash 34a separated from the filter 33 is unlikely to move toward the engine 10 from the ash storage portion 34. Accordingly, it is possible to more appropriately suppress the entry of the ash 34a separated from the filter 33 into the combustion chamber 13 of the engine 10 along with the backflow of the exhaust gas. Therefore, it is possible to suppress damage to the engine 10 due to the ash 34a.

### Modifications of Engine System 100

Next, modifications of the exhaust gas backflow process to be executed by the engine system 100 according to the first embodiment will be described. In the first embodiment, in step S109 of the exhaust gas backflow process, the control device 60 reduces the backflow rate of the exhaust gas through the HP-EGR passage 40 by opening the LP-EGR valve 52 (see FIG. 6). However, the method for reducing the backflow rate of the exhaust gas through the HP-EGR passage 40 in step S109 is not limited to such an example.

For example, according to a first modification, in step S109, the control device 60 may open the exhaust valve 35 while opening the LP-EGR valve 52. The opening degrees of the LP-EGR valve 52 and the exhaust valve 35 are larger than 0% and 100% or smaller. Thus, part of the exhaust gas accumulated in the exhaust passage 30 is recirculated to the intake passage 20 through the LP-EGR passage 50, and the other part of the exhaust gas is discharged to the outside of the vehicle through the exhaust valve 35. As a result, the backflow rate of the exhaust gas through the HP-EGR passage 40 can be reduced.

According to a second modification, in step S109, the control device 60 may open the exhaust valve 35 while opening the LP-EGR valve 52, and reduce the opening degree of the HP-EGR valve 42. The opening degrees of the HP-EGR valve 42, the LP-EGR valve 52, and the exhaust valve 35 are larger than 0% and 100% or smaller. Thus, part of the exhaust gas accumulated in the exhaust passage 30 is recirculated to the intake passage 20 through the LP-EGR passage 50, and the other part of the gas is discharged to the outside of the vehicle through the muffler 36. As a result, the backflow rate of the exhaust gas through the HP-EGR passage 40 can be reduced. Further, the backflow rate of the exhaust gas through the HP-EGR passage 40 can be directly reduced by reducing the opening degree of the HP-EGR valve 42.

As described above, in the first and second modifications, in step S109 of the exhaust gas backflow process, the backflow rate of the exhaust gas is reduced by opening either or both of the exhaust valve 35 and the HP-EGR valve 42 in addition to opening of the LP-EGR valve 52. Thus, the same effects as those of the first embodiment can be obtained. Further, the backflow rate of the exhaust gas can be controlled to an appropriate backflow rate by more finely adjusting the backflow rate. As a result, it is possible to more appropriately suppress the entry of the ash 34a separated from the filter 33 into the engine 10 while appropriately eliminating the clogging of the filter 33 with the ash in the exhaust gas backflow process.

According to a third modification, in step S109, the control device 60 may open the exhaust valve 35 instead of opening the LP-EGR valve 52. When the exhaust valve 35 is opened in step S109, part of the predetermined amount or more of exhaust gas accumulated in the exhaust passage 30 is discharged to the outside of the vehicle through the muffler 36. As a result, the backflow rate of the exhaust gas through the HP-EGR passage 40 can be reduced.

According to a fourth modification, in step S109, the control device 60 may reduce the opening degree of the HP-EGR valve 42 instead of opening the LP-EGR valve 52. In step S109, the backflow rate of the exhaust gas through the HP-EGR passage 40 can be directly reduced by reducing the opening degree of the HP-EGR valve 42.

As described above, in the third and fourth modifications, in step S109 of the exhaust gas backflow process, the backflow rate of the exhaust gas is reduced by opening the exhaust valve 35 or reducing the opening degree of the HP-EGR valve 42 instead of opening the LP-EGR valve 52. Thus, the same effects as those of the first embodiment can be obtained.

In the first embodiment, in the exhaust gas backflow process, the control device 60 reduces the backflow rate of the exhaust gas in one step that is step S109, but the process is not limited to such an example. For example, the control device 60 may reduce the backflow rate of the exhaust gas in multiple steps while monitoring the rate of the decrease in the differential pressure. Thus, the backflow rate of the exhaust gas can be gradually reduced, and therefore the backflow rate of the exhaust gas is not abruptly reduced. Accordingly, the function of removing the ash from the filter 33 by the backflow of the exhaust gas does not decrease more than necessary. Therefore, it is possible to appropriately suppress the entry of the ash 34a into the engine 10 while maintaining the function of removing the ash.

### Second Embodiment

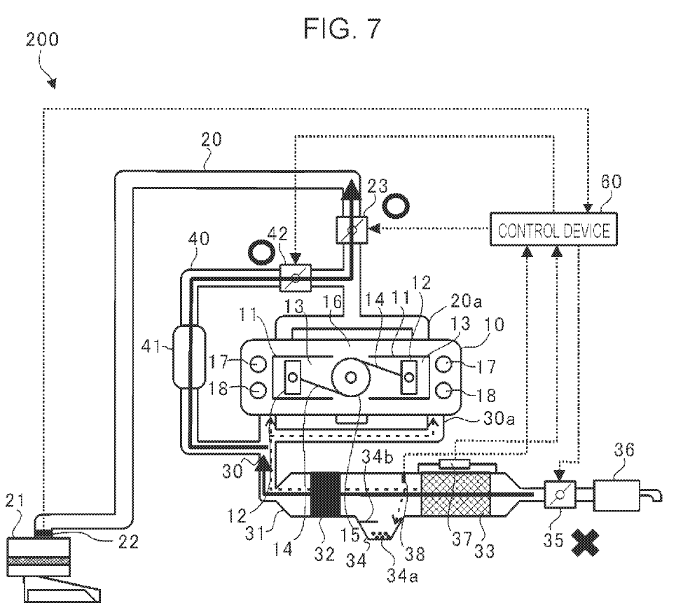

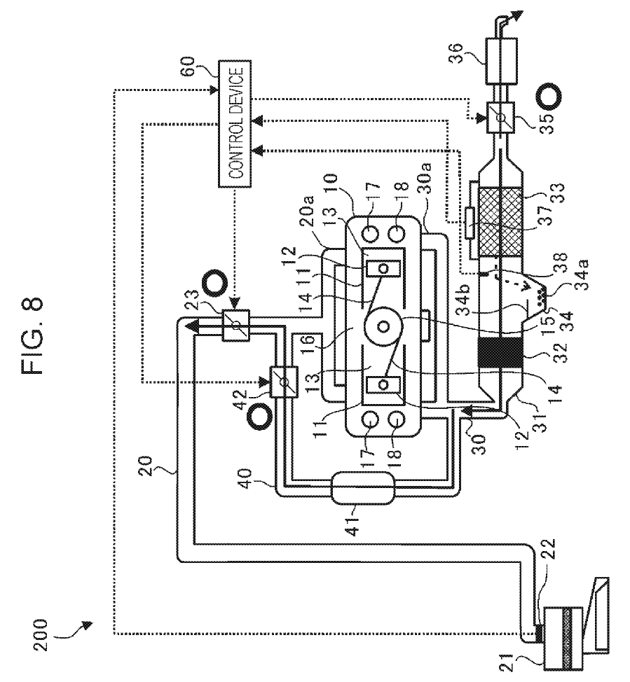

Next, an engine system 200 according to a second embodiment of the disclosure will be described with reference to FIGS. 7 and 8. For convenience of description, components having the same functions as the components of the engine system 100 according to the first embodiment are denoted by the same reference numerals, and description thereof will be omitted. FIGS. 7 and 8 illustrate a flow of exhaust gas according to the second embodiment. FIG. 7 illustrates the opening/closing states of the valves and the flow of the exhaust gas during the exhaust gas backflow control (S107) (before the execution of S109). FIG. 8 illustrates the opening/closing states of the valves and the flow of the exhaust gas when the backflow rate is reduced (S109) during the exhaust gas backflow control (S107).

### Configuration of Engine System 200

As illustrated in FIGS. 7 and 8, the engine system 200 according to the second embodiment includes an engine 10, an intake passage 20, an exhaust passage 30, an HP-EGR passage 40, and a control device 60. The HP-EGR passage 40 is provided with an HP-EGR valve 42. In one embodiment, the HP-EGR passage 40 may serve as the EGR passage. In one embodiment, the HP-EGR valve 42 may serve as the EGR valve.

The engine system 200 according to the second embodiment is different from the engine system 100 (see FIG. 1) according to the first embodiment described above in that the LP-EGR passage 50 is not provided. The components such as the engine 10, the intake passage 20, the exhaust passage 30, the HP-EGR passage 40, and the control device 60 according to the second embodiment have substantially the same configurations as the components of the engine system 100 according to the first embodiment, and thus detailed description thereof will be omitted.

In the engine system 200 according to the second embodiment, the processor 61 of the control device 60 executes steps S100 to S111 included in the exhaust gas backflow process (see FIG. 4) according to the first embodiment described above. Among the steps of the exhaust gas backflow process according to the second embodiment, the processes of step S102 and step S109 are partially different from those of the first embodiment. Therefore, step S102 and step S109 according to the second embodiment will be mainly described below.

### Operation of Engine System 200

In the second embodiment, in step S102 illustrated in FIG. 4, the control device 60 stops recirculation of exhaust gas (EGR gas) from the exhaust passage 30 to the intake passage 20. As illustrated in FIGS. 7 and 8, the engine system 200 includes the HP-EGR passage 40 as a recirculation passage for the exhaust gas from the exhaust passage 30 to the intake passage 20, and does not include the LP-EGR passage 50 (see FIG. 1). Therefore, the control device 60 closes the HP-EGR valve 42 of the HP-EGR passage 40 in step S102. The control device 60 keeps the throttle valve 23 open. When the throttle valve 23 is open, supply of intake air from the intake passage 20 to the engine 10 is maintained, and exhaust gas continues to flow from the engine 10 into the exhaust passage 30.

In the second embodiment, in step S109, the control device 60 reduces the backflow rate of the exhaust gas. For example, the control device 60 reduces the backflow rate of the exhaust gas by opening the exhaust valve 35. Hereinafter, the opening/closing states of the valves and the backflow of the exhaust gas in steps S107 to S111 according to the second embodiment will be described with reference to FIGS. 7 and 8.

As illustrated in FIG. 7, during the execution of the exhaust gas backflow control (S107), the throttle valve 23 and the HP-EGR valve 42 are open, and the exhaust valve 35 is closed. As a result, the exhaust gas accumulated in the exhaust passage 30 flows backward to the intake passage 20 through the HP-EGR passage 40. When the exhaust gas flowing backward passes through the filter 33, the ash deposited on the filter 33 is physically removed and stored in the ash storage portion 34 adjacent to the filter 33.

When the flow rate of the exhaust gas flowing backward through the exhaust passage 30 in the exhaust gas backflow control is excessively high (YES in S108), there is a possibility that, as illustrated in FIG. 7, the ash 34a desorbed from the filter 33 is carried by the exhaust gas excessively flowing backward and enters not only the HP-EGR passage 40 but also the combustion chamber 13 (that is, the cylinder) of the engine 10 without being stored in the ash storage portion 34. When the ash 34a enters the combustion chamber 13 of the engine 10, components of the engine 10 such as the cylinders 11 and piston rings may malfunction, and the durability of the engine 10 such as a durable distance may decrease. To address such an issue, in the second embodiment as well, when the rate of the decrease in the differential pressure of the filter 33 is equal to or greater than the threshold (YES in S108), the control device 60 reduces the backflow rate of the exhaust gas by opening the exhaust valve 35 (S109).

When the control device 60 opens the exhaust valve 35 in step S109, as illustrated in FIG. 8, the throttle valve 23, the HP-EGR valve 42, and the exhaust valve 35 are open. Therefore, part of the exhaust gas accumulated in the exhaust passage 30 is discharged to the outside of the vehicle through the muffler 36. As a result, the backflow rate of the exhaust gas from the exhaust passage 30 to the HP-EGR passage 40 becomes smaller than that before the exhaust valve 35 is opened (see FIG. 7). When the backflow rate of the exhaust gas from the exhaust passage 30 to the HP-EGR passage 40 decreases, the flow rate of the exhaust gas flowing backward in the exhaust passage 30 decreases. Therefore, most of the ash 34a removed from the filter 33 is separated from the low-speed backflow of the exhaust gas, and is stored in the ash storage portion 34. As a result, it is possible to suppress the entry of the ash 34a into the engine 10 along with the backflow of the exhaust gas.

### Effects

Next, effects of the engine system 200 according to the second embodiment will be described.

In the engine system 200 according to the second embodiment, the control device 60 accumulates the exhaust gas in the exhaust passage 30 by closing the exhaust valve 35 and the HP-EGR valve 42. Subsequently, the control device 60 executes the exhaust gas backflow control for causing the exhaust gas accumulated in the exhaust passage 30 to flow backward to the intake passage 20 through the HP-EGR passage 40 by opening the HP-EGR valve 42. Then, the control device 60 reduces the backflow rate of the exhaust gas by opening the exhaust valve 35 based on the rate of the decrease in the differential pressure between the upstream and downstream sides of the filter 33 detected by the sensor (for example, the pressure sensor 37) during the execution of the exhaust gas backflow control. Accordingly, as in the first embodiment, it is possible to suppress the inflow of the ash 34a into the combustion chamber 13 (cylinder) of the engine 10 that may occur when the backflow rate of the exhaust gas is equal to or greater than the predetermined rate during the execution of the exhaust gas backflow control for eliminating clogging of the filter 33. Therefore, it is possible to suppress damage to the engine 10 due to the ash 34a.

### Modifications of Engine System 200

Next, modifications of the exhaust gas backflow process to be executed by the engine system 200 according to the second embodiment will be described. In the second embodiment, in step S109 of the exhaust gas backflow process, the control device 60 reduces the backflow rate of the exhaust gas through the HP-EGR passage 40 by opening the exhaust valve 35 (see FIG. 8). However, the method for reducing the backflow rate of the exhaust gas through the HP-EGR passage 40 in step S109 is not limited to such an example.

For example, according to a first modification, in step S109, the control device 60 may reduce the opening degree of the HP-EGR valve 42. The backflow rate of the exhaust gas through the HP-EGR passage 40 can be directly reduced by reducing the opening degree of the HP-EGR valve 42. Thus, the same effects as those of the second embodiment can be obtained in the first modification.

According to a second modification, in step S109, the control device 60 may reduce the opening degree of the HP-EGR valve 42 while opening the exhaust valve 35. Thus, the same effects as those of the second embodiment can be obtained. Further, the backflow rate of the exhaust gas can be controlled to an appropriate backflow rate by more finely adjusting the backflow rate. As a result, it is possible to more appropriately suppress the entry of the ash 34a separated from the filter 33 into the engine 10 while appropriately eliminating the clogging of the filter 33 with the ash in the exhaust gas backflow process.

In the exhaust gas backflow process according to the second embodiment, the control device 60 reduces the backflow rate of the exhaust gas in one step that is step S109, but the process is not limited to such an example. For example, the control device 60 may reduce the backflow rate of the exhaust gas in multiple steps while monitoring the rate of the decrease in the differential pressure. Thus, the backflow rate of the exhaust gas can be gradually reduced, and therefore the backflow rate of the exhaust gas is not abruptly reduced. Accordingly, the function of removing the ash from the filter 33 by the backflow of the exhaust gas does not decrease more than necessary. Therefore, it is possible to appropriately suppress the entry of the ash 34a into the engine 10 while maintaining the function of removing the ash.

Although the embodiments of the disclosure are described above with reference to the accompanying drawings, the embodiment of the disclosure is not limited to such embodiments. It will be apparent to persons having ordinary skill in the art that various modifications and variations can be made within the scope of the appended claims. It is understood that these modifications and variations are pertinent to the technical scope of the disclosure.

For example, the processes described with reference to the flowchart in this specification need not be executed in the order illustrated in the flowchart. A new processing step may be added, or part of the processing steps may be omitted. The first and second embodiments and various modifications may be combined as appropriate.

According to the embodiments of the disclosure, it is possible to suppress the inflow of the ash into the engine cylinder during the exhaust gas backflow control for eliminating clogging of the filter.

The control device 60 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 60 including the signal acquisition unit 610, the deposition amount estimation unit 612, and the valve control unit 614. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. An engine system comprising:
an engine;
an intake passage coupled to the engine;
an exhaust passage coupled to the engine;
at least one EGR passage that couples the exhaust passage and the intake passage;
a filter provided in the exhaust passage;
a sensor configured to detect a differential pressure of exhaust gas between an upstream side and a downstream side of the filter;
a throttle valve provided in the intake passage;
an exhaust valve provided downstream of the filter in the exhaust passage;
at least one EGR valve provided in the at least one EGR passage; and
a control device configured to control opening and closing of the throttle valve, the exhaust valve, and the at least one EGR valve, wherein
the control device is configured to
accumulate the exhaust gas in the exhaust passage by closing the exhaust valve and the at least one EGR valve, and then execute exhaust gas backflow control for causing the exhaust gas accumulated in the exhaust passage to flow backward to the intake passage by opening the at least one EGR valve, and
reduce a backflow rate of the exhaust gas by opening the exhaust valve or controlling the opening and closing of the at least one EGR valve based on a rate of a decrease in the differential pressure detected by the sensor during execution of the exhaust gas backflow control.

2. The engine system according to claim 1, further comprising an ash storage portion provided upstream of the filter in the exhaust passage, wherein
the ash storage portion is configured to store ash separated from the filter by a backflow of the exhaust gas during the execution of the exhaust gas backflow control.

3. The engine system according to claim 1, wherein
the at least one EGR passage comprises:
a first EGR passage that couples the intake passage and a portion of the exhaust passage upstream of the filter; and
a second EGR passage that couples the intake passage and a portion of the exhaust passage downstream of the filter,
the at least one EGR valve comprises:
a first EGR valve provided in the first EGR passage; and
a second EGR valve provided in the second EGR passage, and
the control device is configured to
accumulate the exhaust gas in the exhaust passage by closing the exhaust valve, the first EGR valve, and the second EGR valve, and then execute the exhaust gas backflow control for causing the exhaust gas accumulated in the exhaust passage to flow backward to the intake passage through the first EGR passage by opening the throttle valve and the first EGR valve, and
reduce the backflow rate of the exhaust gas by opening the second EGR valve based on the rate of the decrease in the differential pressure detected by the sensor during the execution of the exhaust gas backflow control.

4. The engine system according to claim 2, wherein
the at least one EGR passage comprises:
a first EGR passage that couples the intake passage and a portion of the exhaust passage upstream of the filter; and
a second EGR passage that couples the intake passage and a portion of the exhaust passage downstream of the filter,
the at least one EGR valve comprises:
a first EGR valve provided in the first EGR passage; and
a second EGR valve provided in the second EGR passage, and
the control device is configured to
accumulate the exhaust gas in the exhaust passage by closing the exhaust valve, the first EGR valve, and the second EGR valve, and then execute the exhaust gas backflow control for causing the exhaust gas accumulated in the exhaust passage to flow backward to the intake passage through the first EGR passage by opening the throttle valve and the first EGR valve, and
reduce the backflow rate of the exhaust gas by opening the second EGR valve based on the rate of the decrease in the differential pressure detected by the sensor during the execution of the exhaust gas backflow control.

5. The engine system according to claim 1, wherein the control device is configured to
reduce the backflow rate of the exhaust gas by opening the exhaust valve based on the rate of the decrease in the differential pressure detected by the sensor during the execution of the exhaust gas backflow control.

6. The engine system according to claim 2, wherein the control device is configured to
reduce the backflow rate of the exhaust gas by opening the exhaust valve based on the rate of the decrease in the differential pressure detected by the sensor during the execution of the exhaust gas backflow control.

7. The engine system according to claim 1, wherein the control device is configured to
reduce the backflow rate of the exhaust gas by reducing an opening degree of the at least one EGR valve based on the rate of the decrease in the differential pressure detected by the sensor during the execution of the exhaust gas backflow control.

8. The engine system according to claim 2, wherein the control device is configured to
reduce the backflow rate of the exhaust gas by reducing an opening degree of the at least one EGR valve based on the rate of the decrease in the differential pressure detected by the sensor during the execution of the exhaust gas backflow control.

9. An engine system comprising:
an engine;
an intake passage coupled to the engine;
an exhaust passage coupled to the engine;
at least one EGR passage that couples the exhaust passage and the intake passage;
a filter provided in the exhaust passage;
a sensor configured to detect a differential pressure of exhaust gas between an upstream side and a downstream side of the filter;
a throttle valve provided in the intake passage;
an exhaust valve provided downstream of the filter in the exhaust passage;
at least one EGR valve provided in the at least one EGR passage; and
circuitry configured to
control opening and closing of the throttle valve, the exhaust valve, and the at least one EGR valve,
accumulate the exhaust gas in the exhaust passage by closing the exhaust valve and the at least one EGR valve, and then execute exhaust gas backflow control for causing the exhaust gas accumulated in the exhaust passage to flow backward to the intake passage by opening the at least one EGR valve, and
reduce a backflow rate of the exhaust gas by opening the exhaust valve or controlling the opening and closing of the at least one EGR valve based on a rate of a decrease in the differential pressure detected by the sensor during execution of the exhaust gas backflow control.
